(19) United States
(12) Patent Application Publication
(10) Pub. No.: US 2022/0327301 A1
(43) Pub. Date: Oct. 13, 2022

(54) PRE-CONFIGURE SCANNER FOR SUCCESSFUL BLUETOOTH CONNECTION

(71) Applicant: ZEBRA TECHNOLOGIES CORPORATION, Lincolnshire, IL (US)

(72) Inventors: Mariya Wright, Cortland Manor, NY (US); Nina Feinstein, Hicksville, NY (US)

(21) Appl. No.: 17/228,443

(22) Filed: Apr. 12, 2021

(51) Int. Cl. G06K 7/14; H04W 4/80; H04W 76/10

(52) U.S. Cl. CPC G06K 7/1413; H04W 4/80; H04W 76/10

(57) ABSTRACT

Techniques for pre-configuring a barcode reader device for establishing a communication link with a particular computing device via a short-range communication protocol are provided herein. An example method includes sending, by a barcode reader device, a request to a computing device via a first short-range wireless communication protocol (e.g., NFC); receiving, by the barcode reader device, from the computing device, via the first short-range wireless communication protocol, an indication of one or more barcode reader device settings for establishing a short-range communication link with the computing device via a second short-range wireless communication protocol (e.g., Bluetooth®); modifying, by the barcode reader device, the one or more barcode reader device settings as indicated; and establishing, by the barcode reader device, the short-range communication link with the computing device via the second short-range wireless communication protocol.

### BACKGROUND

Cordless barcode reader devices can be configured in a variety of ways to allow for short-range wireless connection (e.g., via Bluetooth®) to a wide variety of possible devices, such as various types of computing devices, including smart phones, tablets, smart watches, laptops, etc. However, in some instances, one set of barcode reader device settings may be required for the barcode reader device to wirelessly connect to one type of computing device, and another (incompatible) set of barcode reader settings may be required for the barcode reader to wirelessly connect to another type of computing device. For instance, one computing device's operating system may require that the barcode reader device has particular barcode reader device settings configured or enabled before it will wirelessly connect to the barcode reader device, and another computing device's operating system may require that the barcode reader device has entirely different barcode reader device settings configured or enabled before it will wirelessly connect to the barcode reader device.

### SUMMARY

In an embodiment, the present invention is a method, comprising: sending, by a barcode reader device, a request to a computing device via a first short-range wireless communication protocol; receiving, by the barcode reader device, from the computing device, via the first short-range wireless communication protocol, an indication of one or more barcode reader device settings for establishing a short-range communication link with the computing device via a second short-range wireless communication protocol; modifying, by the barcode reader device, the one or more barcode reader device settings as indicated; and establishing, by the barcode reader device, the short-range communication link with the computing device via the second short-range wireless communication protocol.

In a variation of this embodiment, the first short-range communication protocol operates within a first frequency range, and wherein the second short-range communication protocol operates within a second frequency range. Additionally, in a variation of this embodiment, each frequency within the first frequency range is lower than any frequencies within the second frequency range.

Moreover, in a variation of this embodiment, the first short-range communication protocol is associated with a first operating range, and the second short-range communication protocol is associated with a second operating range. For instance, in a variation of this embodiment, the first operating range is shorter than the second operating range.

Furthermore, in a variation of this embodiment, the first short-range communication protocol allows communication between the barcode reader device and the computing device without requiring a pre-established bidirectional link between the barcode reader device and the computing device, and the second short-range communication protocol operates pursuant to a bidirectional link between the barcode reader device and the computing device.

In another embodiment, the present invention is a barcode reader device, configured to: send a request to a computing device via a first short-range wireless communication protocol; receive, from the computing device, via the first short-range wireless communication protocol, an indication of one or more barcode reader device settings for establishing a short-range communication link with the computing device via a second short-range wireless communication protocol; modifying the one or more barcode reader device settings as indicated; and establish the short-range communication link with the computing device via the second short-range wireless communication protocol.

In a variation of this embodiment, the first short-range communication protocol operates within a first frequency range, and wherein the second short-range communication protocol operates within a second frequency range. Additionally, in a variation of this embodiment, each frequency within the first frequency range is lower than any frequencies within the second frequency range.

Moreover, in a variation of this embodiment, the first short-range communication protocol is associated with a first operating range, and the second short-range communication protocol is associated with a second operating range. For instance, in a variation of this embodiment, the first operating range is shorter than the second operating range.

Furthermore, in a variation of this embodiment, the first short-range communication protocol allows communication between the barcode reader device and the computing device without requiring a pre-established bidirectional link between the barcode reader device and the computing device, and the second short-range communication protocol operates pursuant to a bidirectional link between the barcode reader device and the computing device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example system for pre-configuring a barcode reader device for establishing a communication link with a particular computing device via a short-range communication protocol.

FIG. 2 illustrates a diagram of example communications between a barcode reader device and a computing device for pre-configuring the barcode reader device for establishing a communication link with a first type of computing device via a short-range communication protocol.

FIG. 3 illustrates a diagram of example communications between a barcode reader device and a computing device for pre-configuring the barcode reader device for establishing a communication link with a second type computing device via a short-range communication protocol.

FIG. 4 illustrates a block diagram of an example method as may be implemented by the system of FIG. 1, for pre-configuring a barcode reader device for establishing a communication link with a particular computing device via a short-range communication protocol.

### DETAILED DESCRIPTION

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Techniques for pre-configuring a barcode reader device for establishing a communication link with a particular computing device via a short-range communication protocol are provided herein.

Some short-range wireless communication protocols, such as near-field communication (“NFC”), allow for nearly instant communication between devices without requiring any pre-established connection between the devices, while other short-range wireless communication protocols, such as Bluetooth®, require the establishment of a bidirectional link between devices before the devices can communicate. In some examples, certain settings of one or both devices must be configured in a particular manner before such a bidirectional link can be established. The particular configuration settings that are required may vary based on factors such as the types of devices involved, the operating systems running on each of the devices, the specific versions of the operating systems running on each of the devices, etc.

Using the techniques provided herein, it is possible for two devices to “handshake” via a first short-range communication protocol, such as NFC, so that an initiating device receives (from the responding device) an indication of what settings must be configured in order to establish a bidirectional link with the responding device via a second short-range communication protocol, such as Bluetooth®.

For example, in order to facilitate seamless connection between a barcode reader device and other computing devices, a barcode reader device may send a request, via a first short-range wireless communication protocol (e.g., via NFC) to a computing device to which it is to be connected. The computing device may respond to the request, via the first short-range wireless communication protocol (e.g., via NFC), with an indication of barcode reader device settings that are required in order for the barcode reader device to establish a bidirectional link with the computing device via a second short-range wireless communication protocol (e.g., via Bluetooth®). The barcode reader may then modify its settings as needed based on the indication received via the first short-range wireless communication protocol, and may then establish the bidirectional link with the computing device via the second short-range wireless communication protocol. Once the wireless communication link is established via the second short-range wireless communication protocol, the barcode reader device and the computing device may communicate using the bidirectional link as needed.

When the barcode reader device needs to connect to another different computing device, this process may restart, i.e., with the barcode reader device sending a request to a new computing device via the first short-range wireless communication protocol, receiving an indication from the new computing device, via the first short-range wireless communication protocol, of barcode reader device settings that are required to establish a bidirectional link with the new computing device via the second short-range communication protocol, modifying its settings as needed, and establishing the bidirectional link with the new computing device via the second short-range communication protocol.

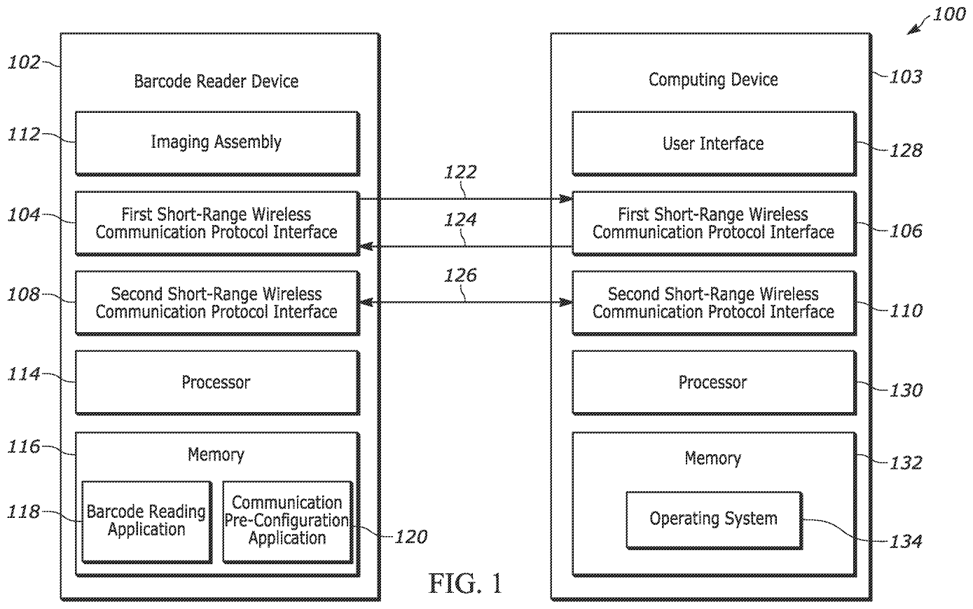

FIG. 1 illustrates a block diagram of an example system 100 for pre-configuring a barcode reader device for establishing a communication link with a particular computing device via a short-range communication protocol. The system 100 may include a barcode reader device 102 and a computing device 103 configured to communicate with one another via a first short-range wireless communication protocol (e.g., NFC) using respective first short-range wireless communication protocol interfaces 104, 106, and communicate with one another via a second short-range wireless communication protocol (e.g., Bluetooth®) using respective second short-range wireless communication protocol interfaces 108, 110.

The barcode reader device 102 may include an imaging assembly 112 configured to capture images of barcodes, as well as the first short-range wireless communication protocol interface 104 and the second short-range wireless communication protocol interface 106. The barcode reader device 102 may further include one or more processors 114 and a memory 116.

The one or more processors 114 may interact with the memory 116 to obtain, for example, computer-readable instructions stored in the memory 116. The computer-readable instructions stored in the memory 116, when executed by the one or more processors 114, may cause the one or more processors 114 to execute a barcode reading application 118 as well as a communication pre-configuration application 120. For instance, executing the barcode reading application 118 may include analyzing images captured by the imaging assembly 104 to decode barcodes in the captured images. Executing the communication pre-configuration application 120 may include sending, via the first short-range communication protocol interface 104, a request 122, for an indication of barcode reader settings required to establish a wireless communication link for communicating via the second short-range wireless communication protocol, to the first short-range wireless communication protocol interface 106. Executing the communication pre-configuration application 120 may further include receiving a response 124, via the first short-range wireless communication protocol interface 104, from the first short-range wireless communication protocol interface 106, indicating various barcode reader device settings required for establishing a wireless communication link for communicating via the second short-range wireless communication protocol (as well as, in some cases, barcode reader device settings associated with user preferences of the user of the computing device 103).

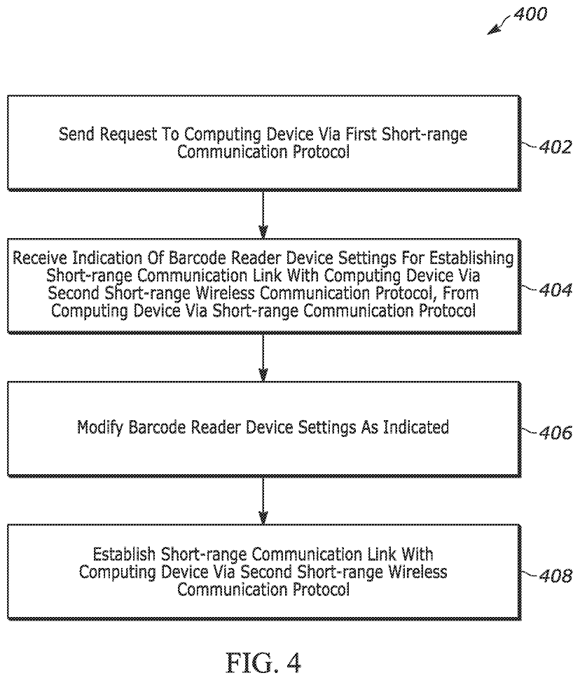

Additionally, executing the communication pre-configuration application 120 may include modifying settings of the barcode reader device 102 as indicated by the response 124. Finally, executing the communication pre-configuration application 120 may include establishing, by the second short-range wireless communication protocol interface 108 of the barcode reader device 102, a wireless communication link 126 with the second short-range communication protocol interface 110 of the computing device 103. For instance, the barcode reader device 102 may send indications of barcodes decoded by the barcode reading application 118 to the computing device 103 via the wireless communication link 126. Furthermore, the computer-readable instructions stored on the memory 112 may include instructions for carrying out any of the steps of the method 400, described in greater detail below with respect to FIG. 4.

The computing device 103 may include a user interface 128 configured to provide information to a user and/or receive inputs from a user (e.g., including user preferences for barcode reader device settings), the first short-range wireless communication protocol interface 106, and the second short-range wireless communication protocol interface 110. The computing device 103 may further include one or more processors 130 and a memory 132.

The one or more processors 130 may interact with the memory 132 to obtain, for example, computer-readable instructions stored in the memory 132. The computer-readable instructions stored in the memory 132, when executed by the one or more processors 130, may cause the one or more processors 130 to run an operating system 134, such as, e.g., a Windows® operating system or an Apple® operating system. Furthermore, the computer-readable instructions stored on the memory 132 may include instructions for receiving, via the first short-range wireless communication protocol interface 106, a request 122, for an indication of barcode reader device settings required to establish a wireless communication link for communicating via the second short-range wireless communication protocol, from the first short-range wireless communication protocol interface 104. Furthermore, the computer-readable instructions stored on the memory 130 may include instructions for sending a response 124, via the first short-range wireless communication protocol interface 106, to the first short-range wireless communication protocol interface 104, indicating various barcode reader device settings required for establishing a wireless communication link for communicating via the second short-range wireless communication protocol (as well as, in some cases, barcode reader device settings associated with user preferences of the user of the computing device 103, e.g., received via the user interface 128).

Finally, the computer-readable instructions stored on the memory 130 may include instructions for establishing, by the second short-range wireless communication protocol interface 110, a wireless communication link 126 with second short-range wireless communication protocol interface 108 of the barcode reader 102. For instance, the computing device 103 may receive indications of barcodes decoded by the barcode reading application 118 from the barcode reader device 102 via the wireless communication link 126. Moreover, the computer-readable instructions stored on the memory 112 may include instructions for carrying out any of the steps of the method 400, described in greater detail below with respect to FIG. 4.

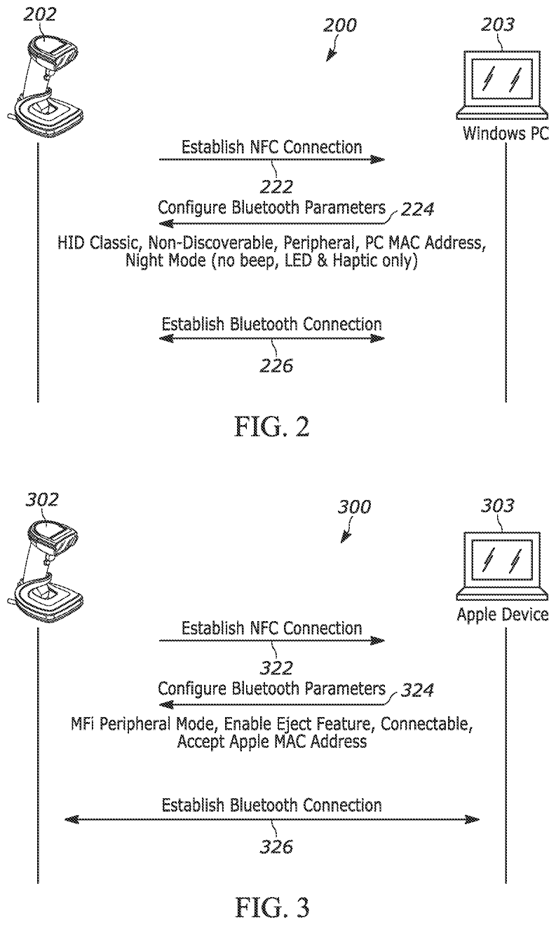

For example, FIG. 2 illustrates a diagram 200 of example communications between a barcode reader device 202 and a computing device 203 for pre-configuring the barcode reader device for establishing a communication link with a first type of computing device via a short-range wireless communication protocol. For instance, the computing device 203 of FIG. 2 may be a Windows® PC device. The barcode reader device 202 may send a request 222 (such as the request 122 discussed above with respect to FIG. 1) to the computing device 203 via a first short-range wireless communication protocol, such as NFC. In response to the request, the computing device 203 may send a response 224 (such as the response 124 discussed above with respect to FIG. 1), via the first short-range wireless communication protocol, including an indication of one or more barcode reader device settings required to establish a connection with the computing device 203 via a second short-range wireless communication protocol, such as Bluetooth®. For instance, as shown at FIG. 2, the barcode reader device settings required to establish the connection with the computing device 203 via the second short-range wireless communication protocol may include enabling an “HID classic” setting, enabling a “non-discoverable” setting, enabling a “peripheral” setting, enabling a “PC MAC address” setting, etc. In some examples, the response 224 may include an indication of one or more barcode reader settings associated with preferences of the user of the computing device 203 (e.g., an indication of a “night mode” barcode reader setting in which LED and Haptic notifications are enabled but audio notifications, such as beeps, are not enabled). The barcode reader 202 may modify its settings to meet the requirements and/or preferences included in the response 224, and may establish a wireless communication link 226 (such as the wireless communication link 126 discussed above with respect to FIG. 1) with the computing device 203 via the second short-range wireless communication protocol.

As another example, FIG. 3 illustrates a diagram 300 of example communications between a barcode reader device 302 and a computing device 303 for pre-configuring the barcode reader device for establishing a communication link with a first type of computing device via a short-range wireless communication protocol. For instance, the computing device 303 of FIG. 2 may be an Apple® device. The barcode reader device 302 may send a request 322 (such as the request 122 discussed above with respect to FIG. 1) to the computing device 303 via a first short-range wireless communication protocol, such as NFC. In response to the request, the computing device 303 may send a response 324 (such as the response 124 discussed above with respect to FIG. 1), via the first short-range wireless communication protocol, including an indication of one or more barcode reader device settings required to establish a connection with the computing device 303 via a second short-range wireless communication protocol, such as Bluetooth®. For instance, as shown at FIG. 3, the barcode reader device settings required to establish the connection with the computing device 203 via the second short-range wireless communication protocol may include enabling an “MFi Peripheral mode” setting, enabling an eject feature, enabling a “connectable” setting, enabling an “accept Apple MAC address” setting, etc. In some examples, the response 324 may include an indication of one or more barcode reader settings associated with preferences of the user of the computing device 303. The barcode reader 302 may modify its settings to meet the requirements and/or preferences included in the response 324, and may establish a wireless communication link 326 (such as the wireless communication link 126 discussed above with respect to FIG. 1) with the computing device 303 via the second short-range wireless communication protocol.

FIG. 4 illustrates a block diagram of an example method 400 as may be implemented by the system of FIG. 1, for pre-configuring a barcode reader device for establishing a communication link with a particular computing device via a short-range communication protocol. One or more steps of the method 400 may be implemented as a set of instructions stored on a computer-readable memory (e.g., memory 112 and/or 126) and executable on one or more processors (e.g., processors 110 and/or 124).

At block 402, a request may be sent to a computing device via a first short-range wireless communication protocol, e.g., by a barcode reader device. For instance, the request may be a request for an indication of barcode reader device settings required for establishing a wireless communication link via a second short-range wireless communication protocol. In some examples, the first short-range wireless communication protocol may be NFC. Additionally, in some examples, the second short-range wireless communication protocol may be Bluetooth®.

In some examples, the first short-range communication protocol may operate within a first frequency range, while the second short-range communication protocol operates within a second frequency range. In some examples, each frequency within the first frequency range is lower than any frequencies within the second frequency range. For instance, the first frequency range may be a range of 10 to 15 MHz, and the second frequency range may be a range of 2400 to 2483.5 MHz.

As another example, the first short-range communication protocol may be associated with a first operating range, and the second short-range communication protocol may be associated with a second operating range. For example, the first short-range communication protocol may be associated with an operating range of 10 cm, while the second short-range communication protocol may be associated with an operating range of 10 m, or an operating range of 100 m.

Moreover, in some examples, the first short-range communication protocol allows communication between the barcode reader device and the computing device without requiring a pre-established bidirectional link between the barcode reader device and the computing device, and the second short-range communication protocol operates pursuant to a bidirectional link between the barcode reader device and the computing device. That is the first short-range communication protocol may allow communications between the two devices without first establishing a bidirectional link between the devices, but the second short-range communication protocol may require that such a link is established before the two devices can communicate, e.g., so that the barcode reader device can send indications of barcode payloads to the computing device.

At block 404, an indication of one or more barcode reader device settings for establishing a short-range communication link with the computing device via a second short-range wireless communication protocol may be received, e.g., by the barcode reader device, from the computing device, via the first short-range wireless communication protocol. In some examples, the indication may include a listing of barcode reader device settings that are required for establishing the communication link. In other examples, the indication may include an indication of one or more of: the type of the device that the computing device is, the operating system running on the computing device, the model or version of the computing device, or other characteristics of the computing device.

Additionally, in some examples, the indication may further include an indication of other barcode reader device settings that the user of the computing device prefers, which may or may not be related to requirements for establishing the communication link with the computing device. For instance, a user of the computing device may prefer a “silent mode” in which the barcode reader device disables an audio indication (e.g., “beep”) when barcodes are read, and the indication from the computing device may include an indication of settings that may be modified in order to accommodate this preference, in addition to any settings required for establishing the communication link with the computing device.

At block 404, the one or more barcode reader settings may be modified as indicated. In some examples, the barcode reader device may modify its settings based on a listing of barcode reader device settings required for establishing the communication link that are sent to the barcode reader device from the computing device. In other examples, the barcode reader device may modify its settings based on one or more of: the type of the device that the computing device is, the operating system running on the computing device, the model or version of the computing device, or other characteristics of the computing device. For instance, the barcode reader device may access a database listing various settings required for establishing a short-range communication link via the second short-range wireless communication protocol for various types of devices, operating systems, models or versions of computing devices, or other computing device characteristics. For example, as shown at FIG. 2, establishing a short-range communication link via Bluetooth® with a computing device that runs a Windows® operating system may require switching to an HID classic mode, switching to a “non-discoverable” mode, enabling a Peripheral mode, and enabling accepting a PC MAC address. As another example, as shown at FIG. 3 establishing a short-range communication link with an Apple® device via Bluetooth® may require switching to an MFi peripheral mode, enabling an eject feature, switching to a “connectable” mode and enabling accepting an Apple MAC address. In some examples, the barcode reader may further modify its settings based on any preferential settings included in the indication received from the computing device, as discussed above with respect to block 404.

At block 406, the short-range communication link between the barcode reader and the computing device may be established via the second short-range wireless communication protocol, i.e., once the settings of the barcode reader device are modified as indicated.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method, comprising:
sending, by a barcode reader device, a request to a computing device via a first short-range wireless communication protocol;
receiving, by the barcode reader device, from the computing device, via the first short-range wireless communication protocol, an indication of one or more barcode reader device settings for establishing a short-range communication link with the computing device via a second short-range wireless communication protocol;
modifying, by the barcode reader device, the one or more barcode reader device settings as indicated; and
establishing, by the barcode reader device, the short-range communication link with the computing device via the second short-range wireless communication protocol.

2. The method of claim 1, wherein the first short-range communication protocol operates within a first frequency range, and wherein the second short-range communication protocol operates within a second frequency range.

3. The method of claim 2, wherein each frequency within the first frequency range is lower than any frequencies within the second frequency range.

4. The method of claim 1, wherein the first short-range communication protocol is associated with a first operating range, and wherein the second short-range communication protocol is associated with a second operating range.

5. The method of claim 4, wherein the first operating range is shorter than the second operating range.

6. The method of claim 1, wherein the first short-range communication protocol allows communication between the barcode reader device and the computing device without requiring a pre-established bidirectional link between the barcode reader device and the computing device, and wherein the second short-range communication protocol operates pursuant to a bidirectional link between the barcode reader device and the computing device.

7. The method of claim 1, wherein the indication further includes an indication of one or more additional barcode reader device settings associated with user preferences of a user of the computing device.

8. A barcode reader device, configured to:
send a request to a computing device via a first short-range wireless communication protocol;
receive, from the computing device, via the first short-range wireless communication protocol, an indication of one or more barcode reader device settings for establishing a short-range communication link with the computing device via a second short-range wireless communication protocol;
modifying the one or more barcode reader device settings as indicated; and
establish the short-range communication link with the computing device via the second short-range wireless communication protocol.

9. The barcode reader of claim 8, wherein the first short-range communication protocol operates within a first frequency range, and wherein the second short-range communication protocol operates within a second frequency range.

10. The barcode reader of claim 9, wherein each frequency within the first frequency range is lower than any frequencies within the second frequency range.

11. The barcode reader of claim 8, wherein the first short-range communication protocol is associated with a first operating range, and wherein the second short-range communication protocol is associated with a second operating range.

12. The barcode reader of claim 11, wherein the first operating range is shorter than the second operating range.

13. The barcode reader of claim 8, wherein the first short-range communication protocol allows communication between the barcode reader device and the computing device without requiring a pre-established bidirectional link between the barcode reader device and the computing device, and wherein the second short-range communication protocol operates pursuant to a bidirectional link between the barcode reader device and the computing device.

14. The barcode reader of claim 8, wherein the indication further includes an indication of one or more additional barcode reader device settings associated with user preferences of a user of the computing device.
